(19) United States
(12) Patent Application Publication
(10) Pub. No.: US 2014/0326236 A1
(43) Pub. Date: Nov. 6, 2014

(54) HIGH ABSORPTIVITY, HEAT RESISTANT COATINGS AND RELATED APPARATUS AND METHODS

(71) Applicants: BRIGHTSOURCE INDUSTRIES (ISRAEL) LTD., Jerusalem (IL); YISSUM RESEARCH DEVELOPMENT COMPANY OF THE HEBREW UNIVERSITY OF JERUSALEM, Jerusalem (IL)

(72) Inventors: Shlomo MAGDASSI, Jerusalem (IL); Daniel MANDLER, Jerusalem (IL); Mubeen BAIDOSSI, Kefar Qara (IL); Liraz LARUSH, Jerusalem (IL); Camille ZWICKER, Jerusalem (IL); Anna NIRENBERG, Modi'in (IL); Yaniv BINYAMIN, Tzur Hadassa (IL)

(73) Assignees: BRIGHTSOURCE INDUSTRIES (ISRAEL) LTD., Jerusalem (IL); YISSUM RESEARCH DEVELOPMENT COMPANY OF THE HEBREW UNIVERSITY OF JERUSALEM, Jerusalem (IL)

(21) Appl. No.: 14/267,751

(22) Filed: May 1, 2014

Related U.S. Application Data
(60) Provisional application No. 61/818,407, filed on May 1, 2013.

(51) Int. Cl. C09D 5/32; F24J 2/48; C09D 183/16

(52) U.S. Cl. CPC C09D 5/32; C09D 183/16; F24J 2/485
USPC 126/676; 106/287.11

(57) ABSTRACT

A paint formulation can include an inorganic oxide-based pigment and an organic binder. The organic binder can be irreversibly converted to an inorganic binder upon curing of the paint formulation at a temperature greater than 200° C. The oxide-based pigment and/or the paint formulation itself can have an absorptivity of at least 80% with respect to the AM 1.5 spectrum. The paint formulation can also include at least one organic solvent, an inorganic filler, and/or at least one additive. Such paint formulations may be stable at high temperatures (e.g., 750° C.) and can be used as solar-radiation-absorbing heat-resistant coatings for components of a solar tower system.

### FIELD

The present disclosure relates generally to formulations for paint, and, more particularly, to solar-radiation-absorbing heat resistant coatings for use in components of a solar tower system.

### SUMMARY

Paint formulations having a high absorptivity with respect to solar radiation are disclosed herein. The disclosed paint formulations are also thermally, environmentally and mechanically durable, thereby enabling the paint formulations to be used on components in solar thermal applications where exposure to high temperatures and environmental conditions may be an issue. The paint formulation can include an inorganic oxide-based pigment, an organic binder, an inorganic filler, at least one organic solvent and one or more additives. The pigment can have a relatively high absorptivity with respect to the AM 1.5 spectrum and can be stable at temperatures greater than 750° C. Curing of the paint formulation can irreversibly convert the organic binder into an inorganic binder.

In embodiments, a paint formulation can include an inorganic oxide-based pigment, an organic binder, an inorganic filler, and at least one organic solvent. The inorganic oxide-based pigment can be at a concentration between 2% (wt/wt) and 40% (wt/wt) and can include at least one selected from a manganese ferrite black spinel, a chromium cobalt iron black spinel, a copper chromite black spinel, and a nickel iron chromite black spinel or any combinations thereof. The organic binder can be at a concentration between 10% (wt/wt) and 60% (wt/wt) and can include at least one selected from a methyl polysiloxane, a phenyl polysiloxane, a medium-hard phenylmethyl silicone resin, a medium-hard high solid phenylmethyl silicone resin, a soft phenylmethyl silicone resin, a dimethyl polysiloxane, a phenyl-methyl polysiloxane, a propyl-phenyl polysiloxane silicone resin or any combinations thereof, or a polydimethylsilazane. The inorganic filler can include at least one selected from mica, micaceous iron oxide, talc, clay or any high temperature plate like filler. The total amount of organic solvent can be at a concentration between 10% (wt/wt) and 60% (wt/wt) and can include a co-solvent which may be used for milling the inorganic oxide-based pigment and a solvent which may be used as a carrier liquid. The co-solvent may be at least one selected from dipropylene glycol mono methyl ether and dipropylene glycol methyl ether acetate. The solvent which may be used as the carrier liquid may be at least one selected from glycol ether, an aromatic naphtha solvent, butyl acetate, 4-Chlorobenzotrifluoride (4-CBTF), toluene, and a member of the xylene family. The inorganic filler can be in the form of particles having a size less than 30 μm. The inorganic oxide-based pigment and/or the paint formulation can have an absorptivity of at least 80% with respect to the AM 1.5 spectrum and may be stable at temperatures greater than 750° C.

In embodiments, a method of painting a metal surface can include electrostatic spraying the paint formulation over the metal surface. The paint formulation can include an inorganic oxide-based pigment, an organic binder, an inorganic filler, and at least one organic solvent. The inorganic oxide-based pigment can be at a concentration between 2% (wt/wt) and 40% (wt/wt) and can include at least one selected from a manganese ferrite black spinel, a chromium cobalt iron black spinel, a copper chromite black spinel, and a nickel iron chromite black spinel or any combinations thereof. The organic binder can be at a concentration between 10% (wt/wt) and 60% (wt/wt) and can include at least one selected from a methyl polysiloxane, a phenyl polysiloxane, a medium-hard phenylmethyl silicone resin, a medium-hard high solid phenylmethyl silicone resin, a soft phenylmethyl silicone resin, a dimethyl polysiloxane, a phenyl-methyl polysiloxane, a propyl-phenyl polysiloxane silicone resin or any combinations thereof, or a polydimethylsilazane. The inorganic filler can include at least one selected from mica, micaceous iron oxide, talc, clay or high temperature plate like filler. The total amount of organic solvent can be at a concentration between 10% (wt/wt) and 60% (wt/wt) and can include a co-solvent which may be used for milling the inorganic oxide-based pigment and a solvent which may be used as a carrier liquid. The co-solvent may be at least one selected from dipropylene glycol mono methyl ether and dipropylene glycol methyl ether acetate. The solvent which may be used as the carrier liquid may be at least one selected from glycol ether, an aromatic naphtha solvent, butyl acetate, toluene, and a member of the xylene family. The method can further include, after the applying, curing the paint formulation at temperature greater than 200° C. such that the organic binder irreversibly converts to an inorganic binder. Paint curing may be accomplished by curing in an oven, by solar curing or by heat generated by an auxiliary boiler. After the curing, the inorganic oxide-based pigment and/or the paint formulation can have an absorptivity of at least 80% with respect to the AM 1.5 spectrum and may be stable at temperatures greater than 750° C.

In embodiments, a paint formulation can include an inorganic oxide-based pigment, an organic binder, at least one organic solvent, an inorganic filler, and at least one additive. The organic binder can be irreversibly converted to an inorganic binder upon curing of the paint formulation at a temperature greater than 200° C. The inorganic oxide-based pigment and/or the paint formulation can have an absorptivity of at least 80% with respect to the AM 1.5 spectrum and may be stable at temperatures greater than 750° C.

In embodiments, a painted metal article can include a metal substrate and a paint layer. The metal article can include steel, alloy steel or a nickel based superalloy. The paint layer can be provided over a surface of the metal layer. The paint layer can include an inorganic oxide-based pigment, an organic binder, at least one organic solvent, an inorganic filler, and at least one additive. The organic binder can be irreversibly converted to an inorganic binder upon curing of the paint formulation at a temperature greater than 200° C. The inorganic oxide-based pigment and/or the paint formulation can have an absorptivity of at least 80% with respect to the AM 1.5 spectrum and may be stable at temperatures greater than 750° C. The inorganic binder can be of the type that is an organic binder prior to curing of the paint layer, which curing irreversibly converts the organic binder into the inorganic binder.

In embodiments, a method of painting a metal article can include applying over an exterior surface of the metal article a paint formulation. The paint formulation can include an inorganic oxide-based pigment, an organic binder, at least one organic solvent, an inorganic filler, and at least one additive. The method can further include, after the applying, curing the paint formulation at temperature greater than 200° C. such that the organic binder irreversibly converts to an inorganic binder. After the curing, the inorganic oxide-based pigment and/or the paint formulation can have an absorptivity of at least 80% with respect to the AM 1.5 spectrum and may be stable at temperatures greater than 750° C.

Objects and advantages of embodiments of the disclosed subject matter will become apparent from the following description when considered in conjunction with the accompanying drawings.

### BRIEF DESCRIPTION OF DRAWINGS

Embodiments will hereinafter be described with reference to the accompanying drawings, which have not necessarily been drawn to scale. Where applicable, some features may not be illustrated to assist in the illustration and description of underlying features. Throughout the figures, like reference numerals denote like elements.

FIG. 1A is a simplified diagram illustrating an elevation view of a solar thermal system with a single solar tower, according to embodiments of the disclosed subject matter.

FIG. 1B is a simplified diagram illustrating an elevation view of a solar thermal system with multiple solar towers, according to embodiments of the disclosed subject matter.

FIG. 2A is a simplified diagram illustrating a top view of pipes in a receiver of a solar tower, according to embodiments of the disclosed subject matter.

FIG. 2B is a simplified diagram illustrating an isometric view of the receiver pipes of FIG. 2A, according to embodiments of the disclosed subject matter.

FIG. 3A is a simplified diagram illustrating a cross-sectional view of one of the receiver pipes of FIG. 2A, according to embodiments of the disclosed subject matter.

FIG. 3B is a simplified diagram illustrating a cross-sectional view of a surface section of the receiver pipe of FIG. 3A, according to embodiments of the disclosed subject matter.

FIG. 4 is a process flow diagram of a method for applying a paint formulation, according to embodiments of the disclosed subject matter.

### DETAILED DESCRIPTION

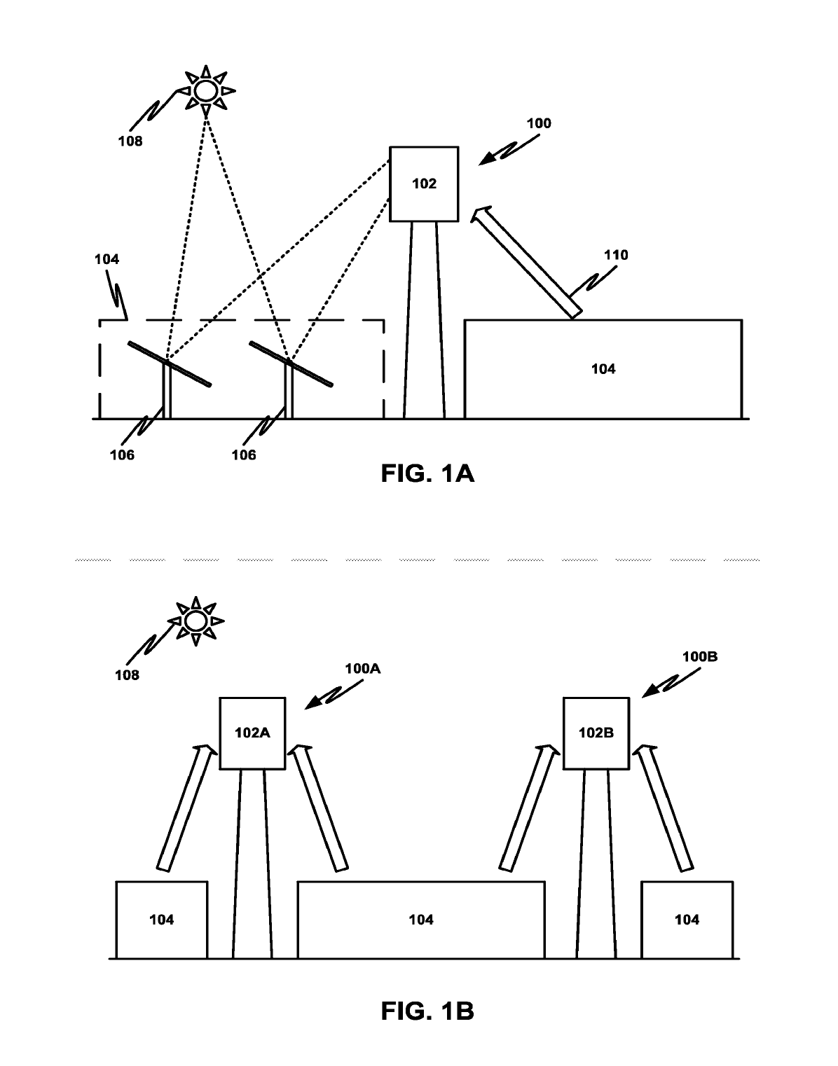

Insolation can be used by a solar thermal system to generate solar steam and/or for heating a fluid, such as a molten salt or a gas, which may subsequently be used in the production of electricity. Referring to FIG. 1A, a solar thermal system employing a single solar tower is shown. The system can include a solar tower 100, which has a target 102 that receives reflected insolation 110 from a solar field 104, which at least partially surrounds the solar tower 100. The solar tower 100 can have a height of, for example, at least 25 m. The target 102 can be a solar energy receiver system, which can include, for example, an insolation receiving surface of one or more solar receivers configured to transmit heat energy of the insolation to a working fluid or heat transfer fluid flowing therethrough. The target 102 may include one or more separates solar receivers (e.g., an evaporating solar receiver and a superheating solar receiver) arranged at the same or different heights or positions. The solar field 104 can include a plurality of heliostats 106, each of which is configured to direct insolation at the target 102 in the solar tower 100. Heliostats 106 within the solar field can adjust their orientation to track the sun 108 as it moves across the sky, thereby continuing to reflect insolation onto one or more aiming points associated with the target 102. The solar field 104 can include, for example, over 50,000 heliostats deployed in over an area of approximately 4 km².

FIG. 1B shows a “multi-tower” version of a solar thermal system. Each tower can have a respective target, which may include one or more solar receivers. The first solar tower 100A has a target 102A thereon and is at least partially surrounded by solar field 104 for receiving reflected insolation therefrom. Similarly, a second solar tower 100B has a target 102B thereon and is at least partially surrounded by solar field 104 for receiving reflected insolation therefrom. For example, the solar receiver in one of the towers may be configured to produce steam from insolation (i.e., an evaporating solar receiver) while the solar receiver in another one of the towers may be configured to superheat the steam using insolation (i.e., a superheating solar receiver). In another example, one or more of the solar towers may have both an evaporating solar receiver and a superheating solar receiver. A limited number of components have been illustrated in FIGS. 1A-1B for clarity and discussion. It should be appreciated that actual embodiments of a solar thermal system can include, for example, optical elements, control systems, sensors, pipelines, generators, and/or turbines.

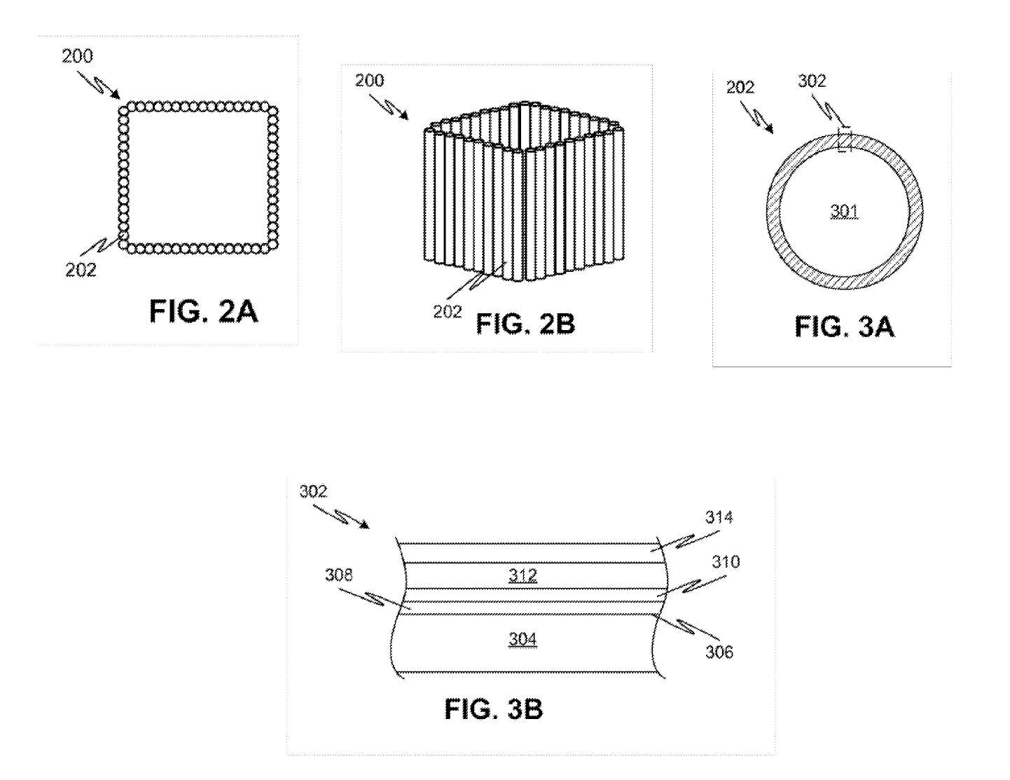

The receiver in each solar tower can include one or more fluid conduits or pipes configured to convey a working fluid or heat transfer fluid at high temperatures and/or pressures. For example, the pipes can be configured to convey pressurized water and/or pressurized steam at temperatures in excess of 290° C. and pressures in excess of 160 bar. Referring to FIGS. 2A-2B, an exemplary configuration of a portion 200 of a solar receiver is shown. Pipes 202 of the receiver portion 200 can be arranged in a single row following a particular geometric configuration, for example, in the shape of a circle, hexagon, or rectangle (as shown in FIG. 2A), or in any other suitable configuration. At least a portion of the exterior surface of each pipe 202 can be arranged to receive insolation reflected by heliostats in the solar field onto the receiver. The solar insolation can heat pipes 202 and thereby heat the fluid therethrough for use in producing electricity or in other applications.

When pipes 202 are constructed from metal, the native surface of the metal may be at least partially reflective to the solar radiation, thereby reducing the efficiency by which heat energy of the insolation is transferred to the fluid flowing through the pipes 202. The metal pipes 202 can thus be treated or painted to maximize or at least improve the solar absorption of the pipes 202. However, high-temperature operation of the solar thermal system (for example, at temperatures in excess of 750° C.) and environmental exposure (for example, to a desert atmosphere where the solar thermal system is located) may adversely affect the outer layers of the metal surface of the pipes 202, including any paint formulation applied thereto.

Paint formulations according to one or more embodiments of the disclosed subject matter can exhibit one or more of the following features:
(1) the paint formulation (and/or a pigment component thereof) has an absorptivity with respect to solar radiation in the wavelength range from 250 nm to 3000 nm (AM 1.5) of greater than 80%, 90%, 95% or greater.
(2) the paint formulation applied to a metal article (e.g., carbon steel, alloy steel, galvanized steel, stainless steel, copper, aluminum and nickel based superalloys) has sufficient thermal durability (i.e., does not ablate over time) to withstand high temperatures (e.g., at least 450° C., 500° C., 550° C., 600° C., 650° C., 750° C., or higher) over a sustained period of time (i.e., hundreds or thousands of consecutive hours under accelerated exposure conditions, for example, at least 1000 hours);
(3) the paint formulation applied to the metal article at a thickness less than or equal to 100 μm does not peel from the article or exhibit cracking after curing;
(4) the paint formulation applied to a metal article at a thickness greater than or equal to 5 μm appears black with no fading;
(5) the paint formulation applied to a metal article at a thickness less than or equal to 100 μm is sufficient to protect the metal article from degradation due to exposure to the elements (for example, protecting the metal article during an acceleration test in an atmosphere of 85% relative humidity (RH) for a period of at least 200 hours, 250 hours, 300 hours, 500 hours or more, and/or an atmosphere of salt fog for a period of 8 hours or more, 16 hours or more, 24 hours or more after 500 hours or more at dry accelerated temperature
(6) the paint formulation applied to a metal article at a thickness less than or equal to 100 μm has sufficient mechanical durability to withstand one or more abrasion tests, for example, falling sand test, such as ASTM D9868.

Such a high-temperature paint formulation for use in a solar thermal system can include (i) an inorganic oxide-based pigment (such as, but not limited to, a black pigment), (ii) an organic binder which irreversibly converts to an inorganic binder (e.g., a ceramic binder) after heating at a high temperature (e.g., at or above 200° C.), (iii) an organic solvent system which may include a carrier liquid solvent and a co-solvent and (iv) an inorganic filler (e.g., a silicate-based solid material that forms layered inorganic microstructures or other inorganic modifying agents).

For example, the paint formulation can be applied to the external surface (or at least a portion thereof) of a pipe assembly of one or more pipes. The paint coating can be provided at a thickness of between 5 μm and 100 μm. Alternatively or additionally, each layer of the paint coating can have a dry thickness less than 100 μm. The paint coating on the pipe assembly can have an inorganic (e.g., ceramic) binder that is produced by first applying the paint formulation over the external surface (i.e., applying the paint formulation either directly to the exterior surface of the metal or applying the paint formulation to an intermediate layer of material over the exterior surface of the metal) at a time when the binder is an organic binder, and subsequently heating the paint formulation (e.g., at a temperature greater than 200° C.) to cure the paint formulation on the pipe, thereby irreversibly converting the organic binder into an inorganic and/or ceramic binder.

The inorganic oxide-based pigment can be formulated such that it does not emit or reflect light in any part (or substantially all) of the visible portion of the electromagnetic spectrum and/or it absorbs all (or substantially all) of the wavelengths of light in the visible portion of the electromagnetic spectrum. The inorganic oxide-based pigment can include a spinel, for example, a manganese ferrite black spinel. For example, the pigment can be an inorganic pigment that is the reaction product of high temperature calcination in which manganese (II) oxide, manganese (III) oxide, iron (II) oxide, and/or iron (III) oxide in varying amounts are homogeneously and ionically interdiffused to form a crystalline matrix of spinel. For example, the spinel can be a manganese ferrite black spinel (such as FeₓMn_{y}CuO, known as Color Index (CI) Name Pigment Black 26 or CI No. 77494 and commercially available as Black 444, Black 10C931, Black 30C933 from The Shepherd Color Company; or Pigment Black 26 24-3060 from Ferro), a chromium cobalt iron black spinel (such as CuCr₂O₄, known as CI Name Pigment Black 27 or CI No. 77502 and commercially available as HEUCODUR HD 955 from Heubach in Germany, or SICOPAL® Black K 0090 from BASF), a copper chromite black spinel (known as CI Name Pigment Black 28 or CI No. 77428 and commercially available as: Black CT1701 from Johnson Matthey; Black 20C980 or Black 30C965 from The Shepherd Color Company; HEUCODUR HD-9-100 from Heubach in Germany), and/or a nickel iron chromite black spinel (known as CI Name Pigment Black 30 or CI No. 77504, and commercially available as Black 376A from The Shepherd Color Company; Black-30 from Johnson Matthey; Black 950 from Heubach in Germany).

The oxide-base pigment can be in the form of particles having a size less than 1 μm, for example, between 0.1 μm and 1 μm, and/or having an average size of less than 1 μm. The pigment in the paint formulation can be at a concentration of between about 5% (wt/wt) and about 30% (wt/wt). For example, the pigment can be at a concentration between about 5% (wt/wt) and about 12% (wt/wt). Other pigment particles that exhibit acceptable absorptivity with respect to solar radiation may also be used so long as such pigment has sufficient high temperature stability (i.e., for temperatures of 750° C. or above).

With respect to the organic binder, a heat resistant polymeric binder can be used. The organic binder can be formulated such that, after curing at high temperatures (e.g., firing at a temperature above 200° C., such as at 500° C.), the organic binder irreversibly converts to an inorganic binder, such as silica or glass. The organic binder can include, for example, at least one of silicone resins, silicone resin copolymers, silicone-polyester resin, silicone-epoxy resins, for example, the organic binder can include a silicone resin selected from a methyl polysiloxane, a phenyl polysiloxane, a medium-hard phenylmethyl silicone resin, a medium-hard high solid phenylmethyl silicone resin, a soft phenylmethyl silicone resin, a dimethyl polysiloxane, a phenyl-methyl polysiloxane, a propyl-phenyl polysiloxane silicone resin or any combinations thereof, or a polydimethylsilazane. In a particular example, 30-80% (wt/wt) phenylmethyl polysiloxane resin (for example, 60-70% (wt/wt)) in xylene can be used.

In some embodiments, it is possible to use any binder(s) or combination thereof including the following binders: Silanes: (1) Poly(phenyl-methylsilane), (from Gelest, USA). Borosiloxanes: (2) Poly (boro-diphenylsiloxane; PBDS), (commercially available as SSP-040 from Gelest, USA). Polysilazanes: (3) Poly1,1 dimethyl silazane telomer (commercially available as SN-2M01-1 from Gelest USA), (4) Poly 1,1-dimethylsilazane Cross linked (commercially available as PSN-2M02 from Gelest, USA), (5) Ceraset PSZ-20 (from AZ Electronic Materials, Germany); (6) Ceraset PURS 20 (from AZ Electronic Materials, Germany), (7). KiON HTT 1800 (from AZ Electronic Materials, Germany); (8) KiON HTA 1500 rapid cure (from AZ Electronic Materials, Germany). Siloxanes: (9) a methyl-phenyl polysiloxane in xylene (commercially available as SILRES® REN 60 or SILRES® REN 80 from Wacker Chemie AG); (10) a propyl-phenyl polysiloxane (commercially available as SILRES® REN 100 from Wacker Chemie AG). Titania (Sol gel): (11) Titania Tyzor TE precursor (triethanolamine titanium Complex; from DuPont, USA). Inorganic binders Sol gel: (12) Alumina sol-gel—Bohamit, Disperal, Disperal P3; AlO(OH) (from Sasol, Germany).

Alternatively or additionally, one or more of the following binders can be used: a phenyl-methyl silicone resin in xylene (commercially available as SILIKOPHEN® P 80/X from Evonik Tego Chemie GmbH), a phenyl-methyl silicone resin having >95% solids, 2-propanol, 1-methoxy, acetate (commercially available as SILIKOPHEN® P 80/MPA from Evonik Tego Chemie GmbH), a phenyl-methyl silicone resin (commercially available as SILIKOPHEN® P 40/W or SILIKOPHEN® P 50/X from Evonik Tego Chemie GmbH), a methyl polysiloxane (commercially available as SILRES® KX from Wacker Chemie AG), a phenyl polysiloxane (commercially available as SILRES® 601 from Wacker Chemie AG), a Silicone resin containing phenyl groups (commercially available as SILRES 602® from Wacker Chemie AG); a Phenylmethyl silicone resin (commercially available as SRP150 from GE Bayer Silicones); a Medium-hard phenylmethyl silicone resin(commercially available as SRP501 from GE Bayer Silicones); a Medium-hard high solid phenylmethyl silicone resin (commercially available as SRP 576 from GE Bayer Silicones); Soft phenylmethyl silicone resin (commercially available as SRP 851 from GE Bayer Silicones).

Selection of the polymer type and ratio of polymer to solids may affect final paint film properties, such as, but not limited to adhesion, optical properties (light absorption and reflection), corrosion resistance, and long term high temperature durability and thermal shock resistance. The binder concentration for the paint formulation can be within a range of 10% (wt/wt) to 80% (wt/wt), for example, between 20% (wt/wt) and 55% (wt/wt). The binder to solids (e.g., filler and pigment) ratio can be between 1:1 and 3:1, for example, between 1:1 and 2:1.

The resistance of the paint formulation to high temperatures can be increased and/or improved by incorporating a high-temperature inorganic filler therein. The inorganic filler can form layered inorganic microstructures when incorporated into the paint formulation. The inorganic filler can include an oxide, silicate, borate, boride, and/or metal flakes. For example, the inorganic filler can include silicate-based solid material (such as mica, platelet-like mica, talc, or clay), a phosphate, and/or magnesium oxide. Examples include, but are not limited to, (i) oxides (e.g., aluminum oxide); (ii) borides of boron, magnesium, aluminum, silicon, or titanium; (iii) plate-like fillers, such as mica, micaceous iron oxide, and talc; (iv) aluminum; (v) calcium metasilicate; and (vi) mixtures thereof. The inorganic filler can be in the form of particles, for example, micron or sub-micron sized particles. The incorporation of the inorganic filler in the paint formulation may serve to enhance high-temperature durability (i.e., at temperatures greater than 350° C., 400° C., 450° C., 500° C., 550° C., 600° C., 750° C. or higher) of the paint formulation.

Alternatively or additionally, one or more of the following fillers and/or glass additives can be used: PLASTORIT® 0000 (Mica, Filler) (available from Imerys Talc, formerly Luzenac America, Inc.) a micaceous iron oxide pigment (MIOX) (commercially available from Rockwood Pigments NA, Inc.), a montmorillonite (commercially available as Montmorillonite K 10 from Sigma-Aldrich), a talc with 10 μm particle size (commercially available as LUZENAC 10M0 f from Imerys Talc, formerly Luzenac America, Inc.), a talc with 20 μm particle size (commercially available as LUZENAC 20M0 from Imerys Talc, formerly Luzenac America, Inc.) an aluminum silicate with a 0.2 μm particle size (commercially available as ASP® G90 from BASF Corporation), an aluminum silicate with a 0.4 μm particle size (commercially available as ASP® 200 from BASF Corporation), a calcined aluminosilicate with a 0.8 μm particle size (commercially available as SATINTONE® 5HB from BASF Corporation), a disodium tetraborate decahydrate (also known as Borax, commercially available from Sigma-Aldrich), modified strontium aluminum polyphosphate hydrate (commercially available as HEUCOPHOS® SRPP from Heubach GmbH), organic modified basic zinc orthophosphate hydrate (commercially available as HEUCOPHOS® ZPO from Heubach GmbH), zinc calcium strontium aluminum orthophosphate silicate hydrate (commercially available as HEUCOPHOS® ZCP-PLUS from Heubach GmbH), zinc aluminum orthophosphate hydrate (commercially available as HEUCOPHOS® ZPA from Heubach GmbH), strontium zinc phosphosilicate (commercially available as HALOX® SZP-391 from Halox), calcium borosilicate (commercially available as HALOX® CW-2230 from Halox), hydrated magnesium silicate (commercially available as NICRON® 403 from Imerys Talc, formerly Luzenac America, Inc.), magnesium oxide-nano (available from Sigma-Aldrich), silicon nitride-nano (available from Sigma-Aldrich), and boron nitride-nano (available from Sigma-Aldrich).

Additionally or alternatively, the inorganic filler can be a material that provides basal cleavage. Incorporation of platelet-like mica into the paint formulation can also strengthen paint adhesion and improve corrosion resistance. In particular, the platelets of the mica align parallel to the surface of the article as the paint dries thereon. This alignment may serve to improve adhesion strength of the paint formulation. Moreover, the platelets may overlap with each other, thereby reinforcing the paint during drying and/or curing. The platelets may also reduce internal stress due to thermal expansion/contraction and increase paint film flexibility and crack-resistance. The platelet-like fillers can also provide a measure of barrier protection, since the platelets align parallel to the article surface and provide low moisture and gas permeability. The relatively high aspect ratio of the individual platelets may also provide beneficial rheological properties and improve sag resistance.

Selection of the filler and the concentration thereof can affect the resulting properties of the paint formulation, such as, but not limited to, optical properties, thermal resistance, adhesion, and corrosion resistance. The filler can be in the form of particles having a size less than 30 μm but greater than 0.5 μm, for example, between 1 μm and 10 μm. The filler in the paint formulation can be at a concentration of between about 1% (wt/wt) and about 20% (wt/wt). For example, the filler can be at a concentration between about 5% (wt/wt) and about 10% (wt/wt).

The paint formulation can be in the form of a liquid composition for application to a surface of an article. The paint formulation can thus include a carrier liquid, such as an aqueous or organic solvent. The solvent can serve as a carrier for the various components of the paint formulation. In addition, the solvent can dissolve the binder of the paint formulation thereby reducing the viscosity thereof to a suitable level for application. Such modes of application can include, but are not limited to, brush, roller, pressure spray, ultrasonic spray, electrostatic spray, and airless spray. After application of the paint formulation, the solvent can evaporate, thus leaving behind the other components of the paint formulation to form the coating on the desired article.

Solvents for the paint formulation can include, for example, glycol ethers, aromatic naphtha solvents, members of the xylene family (e.g., m-xylene, p-xylene, o-xylene, and/or mixtures thereof), butyl acetate, toluene, and combinations thereof. For example, the organic solvent can be at least one of 4-chlorobenzotrifluoride(4-CBTF) propylene glycol mono methyl ether (commercially available as DOWANOL™ PM from Dow Chemical Company), dipropylene glycol mono methyl ether (commercially available as DOWANOL™ DPM from Dow Chemical Company), dipropylene glycol (mono methyl ether acetate) (commercially available as DOWANOL™ DPMA from Dow Chemical Company), tripropylene glycol mono methyl ether (commercially available as DOWANOL™ TPM from Dow Chemical Company), propylene glycol mono n-butyl ether (commercially available as DOWANOL™ PnB from Dow Chemical Company), dipropylene glycol mono butyl ether (commercially available as DOWANOL™ DPnB from Dow Chemical Company), tripropylene glycol mono n-butyl ether (commercially available as DOWANOL™ TPnB from Dow Chemical Company), propylene glycol mono propyl ether (commercially available as DOWANOL™ PnP from Dow Chemical Company), dipropylene glycol mono propyl ether (commercially available as DOWANOL™ DPnP from Dow Chemical Company), propylene glycol butyl ether (commercially available as DOWANOL™ TPnB-H from Dow Chemical Company), propylene glycol mono methyl ether acetate (commercially available as DOWANOL™ PMA from Dow Chemical Company), diethylene glycol mono butyl ether (commercially available as DOWANOL™ DB from Dow Chemical Company), other ethylene or propylene glycol ethers, xylenes (m-xylene, p-xylene, o-xylene or any mixture thereof), t-butyl acetate, n-butyl acetate, and toluene. Other solvents can also be used according to one or more contemplated embodiments in order to comply with environmental requirements related to volatile organic compounds (VOC).

In some embodiments, it is possible to employ a solvent system which includes a solvent and a co-solvent. In some embodiments, a co-solvent may be used to dissolve the inorganic oxide-based pigment. The co-solvent may have an undesirably high evaporation rate. In order to reduce the rate of evaporation a solvent to lower the evaporation rate may be introduced. In some examples, the solvent may be 4-chlorobenzotrifluoride(4-CBTF) and the co-solvent may be dypropylene glycol methyl ether (DPM) and/or glycol methyl ether acetate (DPMA).

The total solvent/co-solvent concentration can be in the range from 10% (wt/wt) to 60% (wt/wt), for example, between 10% (wt/wt) and 45% (wt/wt).

The paint formulation can include additional agents, such as, but not limited to, a wetting agent and a dispersing agent. In certain embodiments, the paint formulation may further include a thickening agent, a de-foaming agent, an anti-foaming agent, an electrostatic spray agent, a spray enhancing agent, an anti-sedimentation agent, a rheological agent, an adhesion promotion agent, and an anti-corrosive agent. The dispersing agents can de-agglomerate the particles in the paint formulation and reduce solid precipitation in the paint formulation. Such dispersing agents can include at least one of, for example, an alkylolammonium salt of a block copolymer with acidic groups (commercially available as DISPERBYK®-180 from BYK Additives), a solution of a carboxylic acid salt of polyamine amides (commercially available as ANTI-TERRA®-204 from BYK Additives), a solution of a copolymer with acidic groups (commercially available as DISPERBY®-110 from BYK Additives), and a copolymer with acidic groups (commercially available as DISPERBYK®-111 from BYK Additives).

The wetting agent can reduce surface tension of the paint formulation and thereby improve paint film properties and adhesion to the surface of the article. Such wetting agents can include a polyether modified poly-dimethyl-siloxane (commercially available as BYK®-333 from BYK Additives). De-foaming agents can include a silicone-free solution of foam destroying polymers (commercially available as BYK®-052, BYK®-054, or BYK®-057 from BYK Additives), a polyacrylate-based surface additive (commercially available as BYK®-392 from BYK Additives), or a silicone-free air release additive (commercially available as BYK®-A 535 from BYK Additives).

The thickening and/or anti-sedimentation agent can provide the desired viscosity of the paint formulation, for example, based on the method of coating and/or to reduce particle sedimentation. Such thickening and/or anti-sedimentation agents can include a solution of a modified urea (commercially available as BYK®-410 from BYK Additives), bentonites, and hydrophobic pyrogen silica (commercially available as AEROSIL® R 972 from Evonik Industries). Electrostatic spray agents may increase the conductivity of the paint formulation to assist in spraying. Such spray agents can include a cationic compound additive (commercially available as EFKA® 6780 from BASF Corporation) or a conductivity promoter for coatings (commercially available as LANCO® STAT L 80 from Lubrizol Deutschland GmbH).

Further additives such as trimethyl borate (TMB) and boroxine (both available from Sigma Aldrich) may be added to the composition.

In some embodiments, a catalyst may be used in the composition in order to enable cross-linking of the binder. Such catalysts may include diethylenetriamine (DETA), triethanolamine (TEA), and trimethylenediamine (TMEDA).

The paint formulation may be applied by itself or in combination with one or more surface treatments or other layers. For example, the metal article may be provided with one or more of the following: (1) a substrate surface treatment (e.g., grit blasting, shot blasting or ball blasting); (2) a high-temperature heat-resistant solar absorbing coating (e.g., the paint formulation).

In an embodiment, the metal article is a pipe 202 of a receiver 200 in a solar thermal system. For example, one or more of the coatings/treatments described herein may be applied to at least a portion of the exterior surface of pipe 202, as shown in FIGS. 3A-3B. FIG. 3B shows a close-up cross-sectional view 302 of pipe 202 of FIG. 3A. It is noted that the layers illustrated in figures have not been drawn to scale. Rather, the relative sizes of the layers have been exaggerated for illustration purposes. Pipe 202 has a metal wall 304 separating an interior volume 301 of pipe 202 from the external environment. Water and/or steam (or other heat transfer or working fluid), which may be preheated and/or pressurized, flows through the pipe interior volume. An exterior surface side 306 of the metal wall 304 can receive reflected insolation from the field of heliostats, so as to heat the metal wall 304 and thereby the flowing water and/or steam. The one or more coatings applied to the exterior surface 306 can improve absorption of solar insolation and/or protect the metal surface.

The exterior surface side 306 of the metal wall 304 can optionally be pre-treated prior to application of any other layers. For example, the surface 306 can be subjected to at least one of grit-blasting, shot blasting and ball blasting. Alternatively or additionally, one or more layers of paint or other formulations can optionally be provided between the paint formulation layer 312 and the pipe surface 306.

The thickness of the solar paint formulation layer 312 can be 5 μm or less, or at least 20 μm, 50 μm, 100 μm or less. After curing, the paint can have a thickness in the range from 50 μm to 100 μm, for example, between 70 μm and 90 μm. Prior to curing, the paint can have a wet film thickness in the range from 50 μm to 100 μm. Alternatively or additionally, each layer of the applied paint formulation can have a wet film thickness of about 50-60 μm.

Alternatively or additionally, one or more additional layers (not shown) can be provided over exterior surface 306, to which the pre-treatment and/or the other layers 308-314 can be applied. Alternatively or additionally, one or more additional layers (not shown) can be provided over exterior surface 306 and the other layers 308-314.

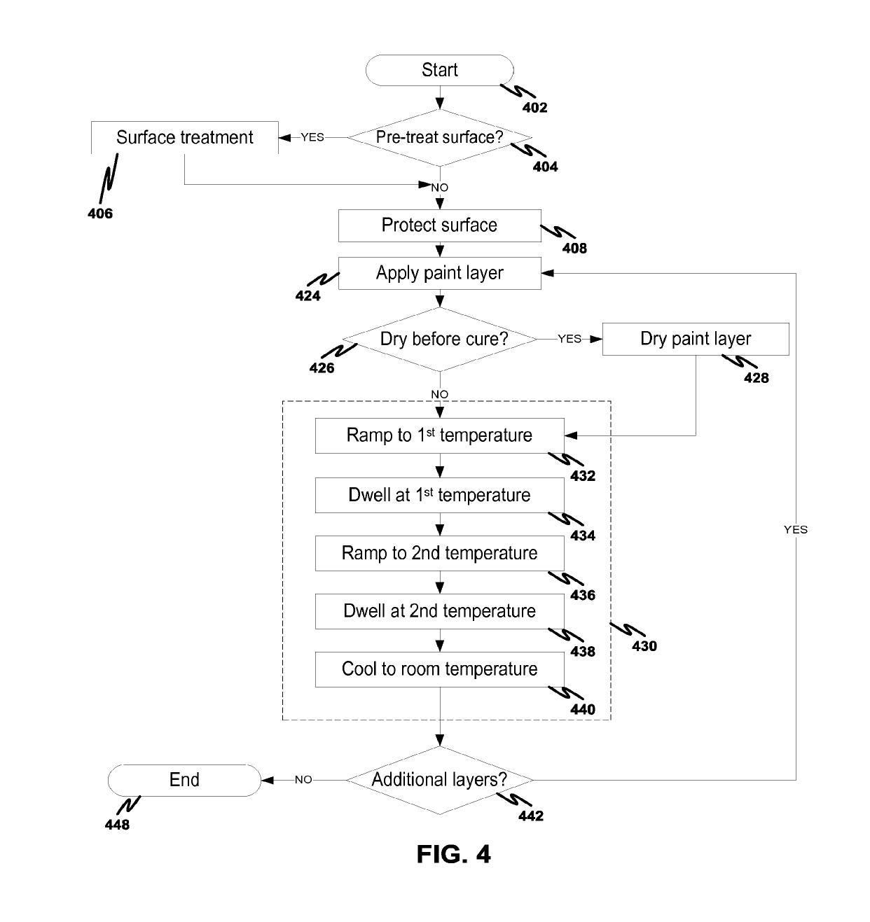

An exemplary method for forming a high-temperature high-solar-absorptivity coating on a metal article, such as that shown in FIGS. 3A-3B, is shown in FIG. 4. The method can begin at 402 and proceed to 404. At 404, it is determined if an optional surface pre-treatment is desired. If no surface treatment is desired, the method proceeds to 408. Otherwise, the method proceeds to 406, where a surface pre-treatment can be applied to the metal surface of the article to be painted (or to another surface of the article to which subsequent coatings will be applied). For example, the surface pre-treatment can be a grit-blasting treatment or ball-blasting treatment or shot-blasting treatment. Deposition of the next layer on the treated surface may be applied within 12 hours. After completion of the surface treatment, the method can proceed to 424.

At 424, a layer of the paint formulation can be applied over the surface of the metal article (or a portion of the surface exposed to solar insolation). The paint formulation can be applied at relatively low temperature, for example, less than 100° C., 60° C., 40° C. or lower, such as at room temperature. The paint formulation can be applied to the surface using any number of application techniques, including but not limited to, brushing, coating using a hand roller, pressure-spraying, electrostatic-spraying, and airless-spraying. The wet thickness of the resulting paint coating on the article can be in the range from 10 μm to 100 μm, with subsequent dried thicknesses (i.e., after curing), in the range from 1 μm to 60 μm. Greater film thicknesses for the paint coating can be obtained by sequentially depositing and curing additional layers on top of a dried/cured paint coating. The method can proceed to 426.

At 426, it is determined if the paint coating should be dried prior to curing. If drying is not desired prior to curing, the method proceeds to curing at 430. Otherwise the method proceeds to 428, where the paint coating is dried. For example, the paint coating can be dried at room temperature (i.e., 25° C.) for several hours (e.g., 24-48 hours). Alternatively or additionally, the paint coating can be dried at an elevated temperature (e.g., within the range from 50° C. to 70° C.) for several hours (e.g., 1-3 hours). After drying the method can proceed to curing at 430, which can include steps 432-440. Curing can be performed at any time after application of the paint coating to the metal article, for example, in the factory or in the field. Any heating source can be used to heat the metal article in the curing process. For example, an oven can be used to raise the temperature of the metal article and to reliably maintain the elevated temperature of the metal article for a given period of time. Alternatively or additionally, curing may be done by solar curing and/or using heat produced in an auxiliary gas boiler. In some examples, for temperatures up to approximately 100° C. hot steam produced in the auxiliary steam boiler may be used to cure the coating. For temperatures greater than approximately 100° C. solar curing procedure may be used.

Curing 430 can begin with ramping the temperature of the metal article to a first elevated temperature at 432. Since the heating rate may affect the final film performance, the ramping can be performed using predefined heating profiles. A heating rate that is too high may result in a porous paint coating, which may exhibit low thermal and/or corrosion resistance. For example, the heating rate can be in the range from 2° C./minute to 20° C./minute. The curing process can be performed at a temperature greater than that of the drying, for example, in the range from 200° C. to 600° C. For example, the first temperature can be 250° C. Thus, the temperature of the metal article can be increased during the first ramp phase 432 from the drying temperature (e.g., 25° C.) to the first temperature (e.g., 250° C.) at the desired heating rate (e.g., 2° C./minute). The method then proceeds to 434.

At 434, the temperature of the metal article is maintained at the first elevated temperature for a predetermined period of time. For example, during this first dwell phase 434, the temperature of the metal article can be maintained at 250° C. for a period of 1 hour. After the dwell phase 434, the method can proceed to 436, where the temperature of the metal article is increased to a second elevated temperature at a second heating rate. For example, the second heating rate can also be in the range from 2° C./minute to 20° C./minute, and the second temperature can be 350° C. Thus, the temperature of the metal article can be increased during the second ramp phase 436 from the first temperature (e.g., 250° C.) to the second temperature (e.g., 350° C.) at the desired heating rate (e.g., 2° C./minute). The method can then proceed to 438, where the temperature of the metal article is maintained at the second elevated temperature for a predetermined period of time. For example, during this second dwell phase 438, the temperature of the metal article can be maintained at 350° C. for a period of 2 hours. Fewer heating/ramping and/or dwell phases can be provided to cure the paint coating. Alternatively, additional heating/ramping and/or dwell phases can be provided to cure the paint coating. For example, a third heating phase can be provided to heat the metal article to a third elevated temperature (e.g., 500° C.) at a third heating rate (e.g., 2° C./minute).

The method can then proceed to 440, where the metal article is slowly cooled to room temperature, for example, by allowing the metal article to cool in the oven with the door thereof ajar. Alternatively or additionally, cooling of the metal article may also be controlled to follow a predefined cooling rate (e.g., a rate between −2° C./minute and −20° C./minute, such as −5° C./minute). After the heating/ramping and/or dwell phases, the paint coating is cured such that the organic binder irreversibly converts to an inorganic binder (e.g., a ceramic binder). The method can then proceed to 442. At 442, it is determined if additional paint coatings are desired, for example, to provide a desired thickness of the paint coating. If so, the method proceeds to 424, where the paint application, drying, and curing processes are repeated. Otherwise the method can terminate at 448.

Durability and reliability of the paint formulation can be verified by subjecting painted articles to one or more accelerated tests pursuant to accepted standards. For example, the following tests can be performed: (1) optical performance test (i.e., a solar absorptivity test); (2) humidity test (85% RH at a temperature of 85° C. for 500 hours); (3) high temperature test (dry heat at a temperature between 600° C. and 750° C. for 1000 hours in air); (4) neutral salt spray test (exposure to salt spray for 8-24 hours); (5) adhesion test—ASTM D3359-08 (Standard Test Method for Measuring Adhesion by Tape); (6) high temperature accelerated life test (ALT) (dry heat, ten cycles at a temperature between 600° C. and 750° C. for 100 hours each cycle, total duration of at least 1000 hours); (7) thermal cycling test between 15° C. and 85° C.

For example, the optical performance test can measure film reflectance/absorptivity according to ASTM D4587-05 (Standard Practice for Fluorescent UV-Condensation Exposures of Paint and Related Coatings). In particular, the test can evaluate the absorptivity of the coatings using a measuring device that provides a reliable indicator of overall absorptivity (i.e., solar spectrum AM 1.5). The measuring device can be any reflectance or absorptivity measuring device known in the art, such as a portable spectrophotometer, for example, 410-Solar manufactured by Surface Optics Corp. The measurement can be taken with an 8 mm diameter aperture and medium aperture value (MAV) setting. Specular component included (SCI) and specular component excluded (SCE) data can be measured. For the illumination, any setting that best approximates the solar spectrum AM 1.5 can be used, for example, D65. For example, measurements can be recorded at wavelengths in the range from 250 nm to 3000 nm at 10 nm intervals. Observation can be at 10° from the surface normal. Separate measurements can be taken at the best location on the coating, the worst location on the coating (excluding edge effects), and at any significant defect or optical anomaly. The measurement data can be compared with the initial data for the sample, for example, to ascertain any changes to optical properties that may result from the one or more thermal or environmental tests. As such, the coating can be measured both before and after all tests in order to determine degradation. Desired target absorptivity for the coating can be at least 97%, although absorptivity values for the solar spectrum as low as 95% may be designated as passing for solar thermal applications.

The humidity test can subject the paint coating to relatively harsh conditions of relatively high humidity. For example, the painted article can be subjected to constant exposure in a humidity chamber at 85° C. and 85% RH for a duration of at least 500 hours. The optical properties of the coating can be checked every 50 hours during the test, for example, using the optical performance test methodology noted above. Visual inspection can also be performed for evidence of corrosion, peeling, and/or other signs of coating degradation. A coated article may be considered to pass the test if it emerges after the 500 hours with less than a 1% change in absorptivity and no visible degradation/damage.

The neutral salt spray (NSS) test can also subject the paint coating to relatively harsh environmental conditions. For example, the NSS test can be conducted in accordance with ASTM B117-09 (Standard Practice for Operating Salt Spray (Fog) Apparatus). The NSS test can be conducted for a time period of 24 consecutive hours. After the test, optical properties can be checked using the optical performance methodology noted above. Visual inspection can also be performed for evidence of corrosion, peeling, and/or other signs of coating degradation. A coated article may be considered to pass the NSS test if it emerges after the 24 hours with less than a 1% change in absorptivity and no visible degradation/damage.

The high temperature test can be used to simulate long-term exposure of the paint coating to high temperatures, for example, as experienced as part of the solar thermal system. For example, the paint coatings can be exposed to dry heat in air at a temperature in the range from 650° C. to 750° C. for at least 1000 hours. The high-temperature exposure may be constant or cyclical. For example, a coating can be exposed to a temperature of 750° C. with 0% RH for 1000 hours, thereby simulating exposure of the coating over a 3-5 year lifespan. The optical properties of the coating can be checked every 100 hours during the test, for example, using the optical performance test methodology noted above. Visual inspection can also be performed for evidence of corrosion, peeling, and/or other signs of coating degradation. A coated article may be considered to pass the test if it emerges after the test with less than a 1% change in absorptivity and no visible degradation/damage.

Some embodiments include a method of producing the high absorptivity coating. In a first step, the inorganic oxide-based pigment may be milled such that it can be in the form of particles having a size less than 1 μm, for example, between 0.1 μm and 1 μm, and/or having an average size of less than 1 μm. In order to mill the inorganic oxide-based pigment, a co-solvent and/or a binder may be added to the inorganic oxide-based pigment. In some examples, a co-solvent such as DPM or DPMA may be added to form a slurry. Alternatively, a binder such as those discussed hereinabove may be added to the inorganic oxide-based pigment to form the slurry. In a further embodiment, the slurry may be formed by adding both the co-solvent and the binder to the inorganic oxide-based pigment. In some embodiments, a dispersant agent and/or a wetting agent may also be added to the slurry, in order to de-agglomerate the pigment particles and to reduce the surface tension of the slurry.

In a second step, the slurry produced in the first step may be mixed with a solvent, a filler, the remainder of the binder, agents and catalysts. The catalyst, which may be used in the composition in order to enable cross-linking of the binder, may be added a short time (e.g. 30 minutes-2 hours) before the application of the coating onto the substrate, thereby optimizing the amount of cross-linking of the binder.

Some embodiments relate to a 2-layered high absorptivity coating. The first layer (i.e. primer coat) may be considered to be “filler-rich”, such that its composition mainly contains a filler but also includes a binder and pigment in lesser amounts. The primer coat may be IR reflective and may be used as a substrate protection layer. The second layer (i.e. topcoat) may be considered to be “pigment-rich”, such that its composition mainly contains a pigment but also includes a binder and filler in lesser amounts. Solvents and agents may added to both layers as necessary.

The following examples are presented in order to more fully illustrate some embodiments of the disclosed subject matter. However, the examples should not be understood to or construed as limiting the scope of the disclosed subject matter.

The following examples illustrate different compositions according to embodiments. Each of these examples demonstrates the effect each component has on the absorptivity of the paint formulation. Some of the variables which have been modified included but are not limited to (i) amount of pigment used, (ii) milling of the pigment, (iii) formation of pigment slurry, (iv) type of filler, (v) amount of filler used, (vi) type of solvent used (i.e. low-VOC solvent), (vii) amount of solvent used, (viii) type of binder used, (ix) amount of binder used.

The paint formulation was applied on different metallic substrates (e.g. T91 steel or Inconel 750° C.) which had been treated prior to paint application. Each paint formulation layer was applied to the plate using spray technique to a wet thickness of approximately 20-100 μm. The paint was cured using the drying/curing profile discussed above, i.e., drying at 25° C. for 18-24 hours, heating in an oven from 25° C. to 250° C. at 2° C./min, dwelling at 250° C. for 1 hour, heating from 250° C. to 350° C. at 2° C. per minute, and dwelling at 350° C. for 2 hours. The painted substrates were then allowed to cool to room temperature, for example, in the oven with the door ajar. Each plate was subjected to a number of the durability/reliability tests described above, including an adhesion test (ASTM D3359-08-Standard), a humidity test (85% RH, 85° C., 250 Hrs, for duration of 500 Hrs), a solar absorptivity test (330-2500 nm), and a heat resistance test.

### Example 1 on T91 Steel

| | [gr] | [%] |
|---|---|---|
| 4-CBTF | 11.3 | 27.52 |
| Disperbyk 110 | 1.03 | 2.50 |
| Byk 333 | 0.19 | 0.46 |
| Byk 54 | 0.01 | 0.02 |
| Anti Terra | 0.03 | 0.07 |
| Silers Ren 100 solution (60% in 4-CBTF) | 19.8 | 48.06 |
| Black 3060 Ferro | 3.23 | 7.83 |
| Mica M | 1.88 | 4.55 |
| DPM | 3.8 | 9.10 |
| Total | 41.2 | 100 |

### Example 1

### Results

| Absorptivity After | Storage time | Dry Film | Adhesion |
|---|---|---|---|
| 1810 Hours@650° C. | [Hrs] | Thickness [μm] | after storage |
| 95.2 | 1804 | 4-12 | 5B |

### Example 2 on T91 Steel

| | [gr] | [%] |
|---|---|---|
| 4-CBTF | 4.25 | 12.15 |
| Disperbyk 110 | 0.9 | 2.57 |
| Byk 333 | 0.15 | 0.43 |
| Byk 54 | 0.006 | 0.02 |
| Anti Terra | 0.02 | 0.06 |
| Silers Ren 100 solution (60% in 4-CBTF) | 15.84 | 45.28 |
| Black 3060 Ferro | 3.5 | 10.01 |
| 40% Borax in EG | 2.82 | 8.06 |
| Luzenac 20 MO | 3 | 8.58 |
| DPM | 4.5 | 12.86 |
| Total | 34.986 | 100.0 |

### Example 2 Results

| Absorptivity After | Storage time | Dry Film | Adhesion |
|---|---|---|---|
| 1810 Hours@650° C. | [Hrs] | Thickness [μm] | after storage |
| 97.5 | 1714 | 7-13 | 4B |

### Example 3 on T91 Steel

Example 3 is a modification of Example 1. The amount of pigment was increased from approximately 8% to approximately 10%.

| | [gr] | [%] |
|---|---|---|
| 4-CBTF | 10.4 | 25.18 |
| Disperbyk 110 | 1.10 | 2.66 |
| Byk 333 | 0.19 | 0.45 |
| Byk 54 | 0.01 | 0.02 |
| Anti Terra | 0.03 | 0.07 |
| Silers Ren 100 solution (60% in 4-CBTF) | 19.8 | 47.94 |
| Black 3060 Ferro | 4.15 | 10.05 |
| Mica M | 1.88 | 4.54 |
| DPM | 3.8 | 9.08 |
| Total | 41.3 | 100.00 |

### Example 3

### Results

| Absorptivity After | Storage time | Dry Film | Adhesion |
|---|---|---|---|
| 1810 Hours@650° C. | [Hrs] | Thickness [μm] | after storage |
| 95.3 | 1714 | 1-7 | 4-5B |

### Example 4 on T91 Steel

Example 4 is a modification of Example 1. The amount of pigment was increased from approximately 10% to approximately 12%.

| | [gr] | [%] |
|---|---|---|
| 4-CBTF | 9.6 | 23.19 |
| Disperbyk 110 | 1.15 | 2.78 |
| Byk 333 | 0.20 | 0.48 |
| Byk 54 | 0.01 | 0.02 |
| Anti Terra | 0.03 | 0.07 |
| Silers Ren 100 solution (60% in 4-CBTF) | 19.8 | 47.83 |
| Black 3060 Ferro | 5.00 | 12.08 |
| Mica M | 1.88 | 4.53 |
| DPM | 3.8 | 9.06 |
| Total | 41.4 | 100.0 |

### Example 4 Results

| Absorptivity After | Storage time | Dry Film | Adhesion |
|---|---|---|---|
| 1810 Hours@650° C. | [Hrs] | Thickness [μm] | after storage |
| 95.6 | 1714 | 1-9 | 3B |

As can be seen in Examples 1, 3 and 4, as the amount of pigment is increased the adhesion of the paint to the substrate decreases.

### Example 5 on T91 Steel

Example 5 is a modification of Example 1. In this example the composition does not include any free solvent.

| | [gr] | [%] |
|---|---|---|
| Disperbyk 110 | 1.03 | 3.45 |
| Byk 333 | 0.19 | 0.63 |
| Byk 54 | 0.01 | 0.03 |
| Anti Terra | 0.03 | 0.10 |
| Silers Ren 100 solution (60% in 4-CBTF) | 19.8 | 66.22 |
| Black 3060 Ferro | 3.23 | 10.79 |
| Mica M | 1.88 | 6.27 |
| DPM | 3.8 | 12.54 |
| Total | 29.9 | 100.0 |

### Example 5

### Results

| Absorptivity After | Storage time | Dry Film | Adhesion |
|---|---|---|---|
| 1810 Hours@650° C. | [Hrs] | Thickness [μm] | after storage |
| 95.7 | 1688 | 7-13 | 4B |

As can be seen in Examples 1, and 5, that without the free solvent the composition does not fare as well in the heat resistant test or the adhesion test.

### Example 6 on T91 Steel

Example 6 is a modification of Example 5. The amount of filler was decreased from approximately 6% to approximately 3%.

| | [gr] | [%] |
|---|---|---|
| Disperbyk 110 | 1.03 | 3.57 |
| Byk 333 | 0.19 | 0.65 |
| Byk 54 | 0.01 | 0.03 |
| Anti Terra | 0.03 | 0.10 |
| Silers Ren 100 solution (60% in 4-CBTF) | 19.8 | 68.51 |
| Black 3060 Ferro | 3.23 | 11.16 |
| Mica M | 0.83 | 2.87 |
| DPM | 3.8 | 12.98 |
| Total | 28.9 | 100 |

### Example 6

### Results

| Absorptivity After | Storage time | Dry Film | Adhesion |
|---|---|---|---|
| 1810 Hours@650° C. | [Hrs] | Thickness [μm] | after storage |
| 95.0 | 1688 | 1-8 | 4B |

### Example 7 on T91 Steel

Example 7 is a modification of Example 6. The binder is mixed with a different solvent.

| | [gr] | [%] |
|---|---|---|
| Disperbyk 110 | 1.03 | 3.57 |
| Byk 333 | 0.19 | 0.65 |
| Byk 54 | 0.01 | 0.03 |
| Anti Terra | 0.03 | 0.10 |
| Silers Ren 100 solution (60% in 4-CBTF) | 19.8 | 68.51 |
| Black 3060 Ferro | 3.23 | 11.16 |
| Mica M -2% | 0.83 | 2.87 |
| DPM | 3.8 | 12.98 |
| Total | 28.9 | 100 |

### Example 7

### Results

| Absorptivity After | Storage time | Dry Film | Adhesion |
|---|---|---|---|
| 1810 Hours@650° C. | [Hrs] | Thickness [μm] | after storage |
| 95.5 | 1688 | 3-12 | 4-5B |

### Example 8 on T91 Steel

Example 8 is a modification of Example 6. The binder is mixed with a different solvent.

| | [gr] | [%] |
|---|---|---|
| Disperbyk 110 | 1.03 | 3.57 |
| Byk 333 | 0.19 | 0.65 |
| Byk 54 | 0.01 | 0.03 |
| Anti Terra | 0.03 | 0.10 |
| Silers Ren 100 solution (60% in t-ButAc) | 19.8 | 68.51 |
| Black 3060 Ferro | 3.23 | 11.16 |
| Mica M -2% | 0.83 | 2.87 |
| DPM | 3.8 | 12.98 |
| Total | 28.9 | 100 |

### Example 8

### Results

| Absorptivity After | Storage time | Dry Film | Adhesion |
|---|---|---|---|
| 1810 Hours@650° C. | [Hrs] | Thickness [μm] | after storage |
| 95.6 | 1688 | 1-9 | 5B |

### Example 9 on T91 Steel

Example 9 is a modification of Example 6. A different pigment is used and it is milled in a solvent.

| | [gr] | [%] |
|---|---|---|
| Disperbyk 110 | 1.03 | 3.43 |
| Byk 333 | 0.19 | 0.62 |
| Byk 54 | 0.01 | 0.02 |
| Anti Terra | 0.03 | 0.10 |
| Silers Ren 100 60% in 4CBTF | 19.8 | 65.78 |
| Black 444 45% milled in DPM | 7.18 | 23.85 |
| Mica M | 1.88 | 6.23 |
| Total | 30.1 | 100.0 |

### Example 9

### Results

| Absorptivity After | Storage time | Dry Film | Adhesion |
|---|---|---|---|
| 1810 Hours@650° C. | [Hrs] | Thickness [μm] | after storage |
| 94.1 | 1688 | 2-9 | 3 |

### Example 10 on T91 Steel

Example 10 is a modification of Example 6. A different pigment is used and it is milled in a polymer.

| | [gr] | [%] |
|---|---|---|
| Disperbyk 110 | 1.03 | 3.45 |
| Byk 333 | 0.19 | 0.63 |
| Byk 54 | 0.01 | 0.03 |
| Anti Terra | 0.03 | 0.10 |
| Silers Ren 100 60% in 4CBTF | 19.8 | 66.22 |
| Black 444 modified t-Bu Poss | 3.23 | 10.79 |
| Mica M -5% | 1.88 | 6.27 |
| DPM | 3.8 | 12.54 |
| Total | 29.9 | 100.0 |

### Example 10

### Results

| Absorptivity After | Storage time | Dry Film | Adhesion |
|---|---|---|---|
| 1810 Hours@650° C. | [Hrs] | Thickness [μm] | after storage |
| 94.9 | 1688 | 3-9 | 3B |

### Example 11 on T91 Steel

Example 11 is a modification of Example 6. A different pigment is used and it is milled in a polymer.

| | [gr] | [%] |
|---|---|---|
| Disperbyk 110 | 1.03 | 3.45 |
| Byk 333 | 0.19 | 0.63 |
| Byk 54 | 0.01 | 0.03 |
| Anti Terra 204 | 0.03 | 0.10 |
| Silers Ren 100 60% in 4CBTF | 19.8 | 66.22 |
| Black 444 modified Phenyl Poss | 3.23 | 10.79 |
| Mica M -5% | 1.88 | 6.27 |
| DPM | 3.8 | 12.54 |
| Total | 29.9 | 100.0 |

### Example 11 Results

| Absorptivity After | Storage time | Dry Film | Adhesion |
|---|---|---|---|
| 1810 Hours@650° C. | [Hrs] | Thickness [μm] | after storage |
| 95.2 | 1688 | 7-17 | 3B |

As can be seen in Examples 9-11, the adhesion of the paint formulation is affected by the changes made to the pigment and the process in which it is prepared.

### Example 12 on T91 Steel

Example 12 is a paint formulation which uses a polysilazane polymer as a binder. The formulation does not include any free solvent.

| | [gr] | [%] |
|---|---|---|
| KiON HTA 1500 Rapid Cure | 10.37 | 48.64 |
| 4CBTF | 0.00 | 0.00 |
| 45% Black 444 (45% milled in DPM) | 10.05 | 47.12 |
| BYK-333 | 0.90 | 4.24 |
| Total | 21.33 | 100.00 |

### Example 12

### Results

| Absorptivity After | Storage time | Dry Film | Adhesion |
|---|---|---|---|
| 1810 Hours@650° C. | [Hrs] | Thickness [μm] | after storage |
| 95.5 | 1563 | 28-35 | 3-4 |

### Example 13 on T91 Steel

Example 13 is a paint formulation which uses a polysilazane polymer as a binder. The formulation is a modification of Example 12.

| | [gr] | [%] |
|---|---|---|
| KiON HTA 1500 Rapid Cure | 10.37498 | 61.39 |
| 4CBTF | 0 | 0.00 |
| Black 444 modified Phenyl Poss | 4.52 | 26.75 |
| BYK-333 | 0.904485 | 5.35 |
| Disperbyk 110 | 1.1 | 6.51 |
| Total | 16.9 | 100.00 |

### Example 13

### Results

| Absorptivity After | Storage time | Dry Film | Adhesion |
|---|---|---|---|
| 1810 Hours@650° C. | [Hrs] | Thickness [μm] | after storage |
| 95.9 | 1563 | 3-9 | 4B |

### Example 14 on T91 Steel

Example 14 is a paint formulation which uses a polysilazane polymer as a binder. The formulation is a modification of Example 12.

| | [gr] | [%] |
|---|---|---|
| KiON HTA 1500 Rapid Cure | 13.83 | 55.24 |
| Black 444 (45% milled in DPMA) | 8.00 | 31.95 |
| BYK-333 | 1.21 | 4.82 |
| Mica M | 2.00 | 7.99 |
| Total | 25.04 | 100.00 |

### Example 14

### Results

| Absorptivity After | Storage time | Dry Film | Adhesion |
|---|---|---|---|
| 1810 Hours@650° C. | [Hrs] | Thickness [μm] | after storage |
| 95.1 | 1563 | 32-36 | 3B |

### Example 15 on T91 Steel

Example 15 is a paint formulation which uses a polysilazane polymer as a binder. The formulation is a modification of Example 12.

| | [gr] | [%] |
|---|---|---|
| HTA-1500 as binder, Clarient | 13.83 | 57.54 |
| 45% Black 444 (45% milled in DPMA) | 8.00 | 33.28 |
| BYK-333 | 1.21 | 5.02 |
| Mica M | 1.00 | 4.16 |
| Total | 24.04 | 100.00 |

### Example 15 Results

| Absorptivity After | Storage time | Dry Film | Adhesion |
|---|---|---|---|
| 1810 Hours@650° C. | [Hrs] | Thickness [μm] | after storage |
| 94.6 | 1563 | 8-13 | 4B |

As can be seen in Examples 14-15, with a decrease in the amount of filler (Example 15) there is a slight drop in the absorptivity. However there is better adhesion and a smaller dry film thickness.

### Example 16 on T91 Steel

Example 16 is a modification of Example 5. In this example the composition comprises a different pigment.

| | [gr] | [%] |
|---|---|---|
| Disperbyk 110 | 1.03 | 3.34 |
| Byk 333 | 0.19 | 0.61 |
| Byk 54 | 0.01 | 0.02 |
| Anti Terra 204 | 0.03 | 0.10 |
| Silers Ren 100 60% in 4-CBTF | 19.8 | 64.08 |
| Black 444 modified t-Bu Poss | 4.20 | 13.59 |
| Mica M | 1.88 | 6.07 |
| DPM | 3.8 | 12.14 |
| Total | 30.9 | 100 |

### Example 16

### Results

| Absorptivity After | Storage time | Dry Film | Adhesion |
|---|---|---|---|
| 1810 Hours@650° C. | [Hrs] | Thickness [μm] | after storage |
| 95.0 | 1563 | 4-13 | 4B |

As can be seen in Examples 1, and 16, with a change in pigment type the composition has a slightly less absorptivity and does not fare as well in the heat resistant test.

### Example 17 on T91 Steel

Example 17 is a modification of Example 16. In this example the pigment is mixed with a different solvent.

| | [gr] | [%] |
|---|---|---|
| Disperbyk 110 | 1.03 | 3.34 |
| Byk 333 | 0.19 | 0.61 |
| Byk 54 | 0.01 | 0.02 |
| Anti Terra 204 | 0.03 | 0.10 |
| Silers Ren 100 60% in 4-CBTF | 19.8 | 64.08 |
| Black 444 modified Phenyl Poss | 4.20 | 13.59 |
| Mica M | 1.88 | 6.07 |
| DPM | 3.8 | 12.14 |
| Total | 30.9 | 100 |

### Example 17

### Results

| Absorptivity After | Storage time | Dry Film | Adhesion |
|---|---|---|---|
| 1810 Hours@650° C. | [Hrs] | Thickness [μm] | after storage |
| 95.2 | 1563 | 16-22 | 3B |

As can be seen in Examples 16, and 17, with a change in the solvent that is mixed with the pigment, the composition is not as adhesive and has a larger dry film thickness.

### Example 18 on T91 Steel

Example 18 is a modification of Example 17. In this example the binder is mixed with a different solvent.

| | [gr] | [%] |
|---|---|---|
| Disperbyk 110 | 1.03 | 3.34 |
| Byk 333 | 0.19 | 0.61 |
| Byk 54 | 0.01 | 0.02 |
| Anti Terra 204 | 0.03 | 0.10 |
| Silers Ren 100 solution (60% in t-ButAc) | 19.8 | 64.08 |
| Black 444 in Poss Phenyl | 4.20 | 13.59 |
| Mica M -5% | 1.88 | 6.07 |
| DPM | 3.8 | 12.14 |
| Total | 30.9 | 100 |

### Example 18 Results

| Absorptivity After | Storage time | Dry Film | Adhesion |
|---|---|---|---|
| 1810 Hours@650° C. | [Hrs] | Thickness [μm] | after storage |
| 95.1 | 1718 | 5-11 | 4-5B |

As can be seen in Examples 17, and 18, with a change in the solvent that is mixed with the binder, the composition performs a lot better in heat resistant test, is more adhesive and has a smaller dry film thickness.

### Example 19 on T91 Steel

Example 19 is a modification of Example 9. In this example the binder is mixed with a different solvent.

| | [gr] | [%] |
|---|---|---|
| Disperbyk 110 | 1.03 | 3.19 |
| Byk 333 | 0.19 | 0.58 |
| Byk 54 | 0.01 | 0.02 |
| Anti-Terra-204 | 0.03 | 0.09 |
| Silers Ren 100 solution (60% in Xylene) | 19.8 | 61.30 |
| Black 444 45% milled in DPM | 9.33 | 28.90 |
| Mica M | 1.88 | 5.80 |
| Total | 32.3 | 100 |

### Example 19

### Results

| Absorptivity After | Storage time | Dry Film | Adhesion |
|---|---|---|---|
| 1810 Hours@650° C. | [Hrs] | Thickness [μm] | after storage |
| 95.0 | 1718 | 5-13 | 4B |

### Example 20 on T91 Steel

Example 20 is a modification of Example 19. In this example a different pigment is used.

| | [gr] | [%] |
|---|---|---|
| Disperbyk 110 | 1.03 | 3.19 |
| Byk 333 | 0.19 | 0.58 |
| Byk 54 | 0.01 | 0.02 |
| Anti Terra 204 | 0.03 | 0.09 |
| Silers Ren 100 solution (60% in Xylene) | 19.8 | 61.30 |
| Black 3060 Ferro 45% milled in DPM | 9.33 | 28.90 |
| Mica M | 1.88 | 5.80 |
| Total | 32.3 | 100 |

### Example 20

### Results

| Absorptivity After | Storage time | Dry Film | Adhesion |
|---|---|---|---|
| 1810 Hours@650° C. | [Hrs] | Thickness [μm] | after storage |
| 94.7 | 1718 | 2-8 | 4B |

### Example 21 on Inconel 750C

| NAY78 (CZ451C-1-In) | [gr] | [%] |
|---|---|---|
| Poly(1,1 dimethylsilazane) | 6.3 | 46.6 |
| 4-CBTF | 2.2 | 16.3 |
| Black 444 (45% milled in DPMA) | 3.31 | 24.5 |
| Diethylen-tri amine | 1.70 | 12.5 |
| Total | 13.505 | 100.0 |

### Example 21

### Results

| Absorptivity After | Storage time | Dry Film | Adhesion |
|---|---|---|---|
| 1810 Hours@650° C. | [Hrs] | Thickness [μm] | after storage |
| 95.5 | 1501 | 25-36 | 3-4B |

### Example 22 on Inconel 750C

Example 22 is a modification of Example 21. In this example less catalyst is used.

| | [gr] | [%] |
|---|---|---|
| Poly(1,1 dimethylsilazane) | 6.3 | 49.8 |
| 4CBTF | 2.1 | 16.6 |
| Black 444 (45% milled in DPMA) | 3.31 | 26.1 |
| Diethylen-tri amine (20% in 4CBTF) | 0.85 | 6.7 |
| Mica M | 0.105 | 0.8 |
| Total | 12.665 | 100 |

### Example 22

### Results

| Absorptivity After | Storage time | Dry Film | Adhesion |
|---|---|---|---|
| 1810 Hours@650° C. | [Hrs] | Thickness [μm] | after storage |
| 96.8 | 1572 | 6-16 | 4B |

### Example 23 on Inconel 750C

Example 23 is a modification of Example 21 In this example less catalyst and no hinder is used.

| | [gr] | [%] |
|---|---|---|
| Poly(1,1 dimethylsilazane) | 6.3 | 49.76 |
| 4CBTF | 2.2 | 17.38 |
| Black 444 (45% milled in DPMA) | 3.31 | 26.15 |
| Diethylen-tri amine (20% in 4CBTF) | 0.85 | 6.71 |
| Total | 12.66 | 100 |

### Example 23

### Results

| Absorptivity After | Storage time | Dry Film | Adhesion |
|---|---|---|---|
| 1810 Hours@650° C. | [Hrs] | Thickness [μm] | after storage |
| 96.6 | 1572 | 8-15 | 4-5B |

As can be seen in Examples 21-23, with a reduction in the amount of catalyst used, the paint formulation increases in performance. There is a further enhancement when the filler is eliminated from the composition.

### Example 24 on Inconel 750C

Example 24 is a modification of Example 22. In this example less solvent is used.

| | [gr] | [%] |
|---|---|---|
| Poly(1,1 dimethylsilazane) | 6.3 | 52.7 |
| 4-CBTF | 1.4 | 11.6 |
| Black 444 (45% milled in DPMA) | 3.31 | 27.7 |
| Diethylen-tri amine (20% in 4-CBTF) | 0.85 | 7.1 |
| Mica M | 0.105 | 0.9 |
| Total | 11.95 | 100.0 |

### Example 24

### Results

| Absorptivity After | Storage time | Dry Film | Adhesion |
|---|---|---|---|
| 1810 Hours@650° C. | [Hrs] | Thickness [μm] | after storage |
| 95.9 | 1572 | 12-16 | 3B |

### Example 25 on Inconel 750C

Example 25 is a modification of Example 22. In this example no solvent is used.

| | [gr] | [%] |
|---|---|---|
| Poly(1,1 dimethylsilazane) | 6.3 | 59.7 |
| 4-CBTF | 0 | 0 |
| Black 444 (45% milled in DPMA) | 3.31 | 31.3 |
| Diethylen-tri amine (20% in 4-CBTF) | 0.85 | 8.0 |
| Mica M | 0.11 | 1.0 |
| Total | 10.56 | 100.0 |

### Example 25

### Results

| Absorptivity After | Storage time | Dry Film | Adhesion |
|---|---|---|---|
| 1810 Hours@650° C. | [Hrs] | Thickness [μm] | after storage |
| 96.2 | 1572 | 12-26 | 4B |

### Example 26 on Inconel 750C

Example 26 is a modification of Example 24. In this example less solvent is used.

| | [gr] | [%] |
|---|---|---|
| Poly(1,1 dimethylsilazane) | 6.3 | 56.0 |
| 4-CBTF | 0.7 | 6.2 |
| Black 444 (45% milled in DPMA) | 3.31 | 29.4 |
| Diethylen-tri amine (20% in 4-CBTF) | 0.85 | 7.5 |
| Mica M | 0.105 | 0.9 |
| Total | 11.265 | 100.0 |

### Example 26 Results

| Absorptivity After | Storage time | Dry Film | Adhesion |
|---|---|---|---|
| 1810 Hours@650° C. | [Hrs] | Thickness [μm] | after storage |
| 96.9 | 1572 | 13-24 | 5B |

### Example 27 on Inconel 750C

Example 27 is a modification of Example 24. In this example a different solvent is used.

| | [gr] | [%] |
|---|---|---|
| Poly(1,1 dimethylsilazane) | 6.3 | 52.7 |
| Xylene | 1.4 | 11.6 |
| Black 444 (45% in DPMA); | 3.31 | 27.7 |
| Diethylen-tri amine (20% in Xylene) | 0.85 | 7.1 |
| Mica M | 0.105 | 0.9 |
| Total | 11.951 | 100.0 |

### Example 27

### Results

| Absorptivity After | Storage time | Dry Film | Adhesion |
|---|---|---|---|
| 1810 Hours@650° C. | [Hrs] | Thickness [μm] | after storage |
| 96.9 | 1572 | 18-34 | 4B |

### Example 28 on Inconel 750C

Example 28 is a modification of Example 26. In this example a different solvent is used.

| | [gr] | [%] |
|---|---|---|
| Poly(1,1 dimethylsilazane) | 6.3 | 56.0% |
| Xylene | 0.7 | 6.2% |
| Black 444 (45% milled in DPMA) | 3.31 | 29.4% |
| Diethylen-tri amine (20% in Xylene) | 0.85 | 7.5% |
| Mica M | 0.105 | 0.9% |
| Total | 11.265 | 100.0% |

### Example 28

### Results

| Absorptivity After | Storage time | Dry Film | Adhesion |
|---|---|---|---|
| 1810 Hours@650° C. | [Hrs] | Thickness [μm] | after storage |
| 96.3 | 1572 | 5-19 | 4B |

### Example 29 on Inconel 750C

Example 29 is a modification of Examples 24 and 27. In this example a different solvent is used.

| | [gr] | [%] |
|---|---|---|
| Poly(1,1 dimethylsilazane) | 6.3 | 52.7 |
| t-Bytyl Acetate | 1.4 | 11.6 |
| Black 444 (45% milled in DPMA) | 3.31 | 27.7 |
| Diethylen-tri amine (20% in t-BuAc)) | 0.85 | 7.1 |
| Mica M | 0.105 | 0.9 |
| Total | 11.951 | 100.0 |

### Example 29

### Results

| Absorptivity After | Storage time | Dry Film | Adhesion |
|---|---|---|---|
| 1810 Hours@650° C. | [Hrs] | Thickness [μm] | after storage |
| 95.6 | 1572 | 7-27 | 5B |

### Example 30 on Inconel 750C

Example 30 is a modification of Examples 26 and 28. In this example a different solvent is used.

| | [gr] | [%] |
|---|---|---|
| Poly(1,1 dimethylsilazane) | 6.3 | 56.0% |
| t-Bytyl Acetate | 0.7 | 6.2% |
| Black 444 (45% in DPMA); | 3.31 | 29.4% |
| Diethylen-tri amine (20% in t-BuAc) | 0.85 | 7.5% |
| Mica M | 0.105 | 0.9% |
| Total | 11.265 | 100.0% |

### Example 30

### Results

| Absorptivity After | Storage time | Dry Film | Adhesion |
|---|---|---|---|
| 1810 Hours@650° C. | [Hrs] | Thickness [μm] | after storage |
| 95.7 | 1576 | 13-26 | 3-4B |

As can be seen in Examples 24 and 26-30, the type of solvent and the amount of solvent used in conjunction with a polysilazane binder affects the absorptivity of the paint coating, the dry film thickness, the adhesion as well as the heat resistance of the coating.

### Comparative Example 1

Commercially available solar paint Pyromark®-2500 was applied in two layers to each of five carbon steel plates (having a size of 60 mm×60 mm), which had been grit-blasted prior to paint application. Each paint layer was applied to the plate using a hand roller coating technique to a wet thickness of approximately 100 μm. Each paint layer was applied and cured before application of the subsequent paint layer. Thus, each paint layer was cured separately. Each paint layer was cured using a drying/curing profile of drying at room temperature (e.g., 25° C.) for 24 hours, heating in an oven from 25° C. to 250° C. at 2° C./min, dwelling at 250° C. for 1 hour, heating from 250° C. to 350° C. at 2° C. per minute, and dwelling at 350° C. for 2 hours. The painted plates were then allowed to cool to room temperature, for example, in the oven with the door ajar. The final dry film thickness was in the range of 50 μm to 60 μm.

Each plate of Comparative Example 1 was subjected to a number of the durability/reliability tests described above, including an adhesion test, a humidity test, a solar absorptivity test, and a heat resistance test. The results are summarized in Table 11. The Comparative Example 1 demonstrated excellent adhesion, but the coating failed the humidity test. Moreover, the film absorptivity after curing (i.e., after 2 hours @ 350° C.) was 96-96.5%, but after 100 hours at 600° C. the absorptivity decreased dramatically to 85-90%. The paint of the Comparative Example 1 was therefore unacceptable for use in a solar thermal system.

TABLE 11
Results of comparative example 1 paint formulation.

| | | | Coating Absorptivity | |
|---|---|---|---|---|
| Tests | | | (% SCI) | |
| | | Neutral Salt Spray | After 2 hrs | After 100 hrs |
| Adhesion | Humidity | (8 hrs & 24 hrs) | @ 350° C. | @ 600° C. |
| Excellent | Failed | N/A | 96-96.5 | 85-90 |

### Comparative Example 2

Comparative Example 2 was prepared using the same formulation and methodology as Comparative Example 1, but PLASTORIT® 0000 has been added to the Pyromark®-2500. Each plate of Comparative Example 2 was subjected to a number of the durability/reliability tests described above, including an adhesion test, a humidity test, a solar absorptivity test, and a heat resistance test. The results are summarized in Table 12. The Comparative Example 2 also demonstrated excellent adhesion, but the coating failed the humidity test. Moreover, the film absorptivity after curing (i.e., after 2 hours @ 350° C.) was 96-96.5%, but after 100 hours at 600° C. the absorptivity decreased to 93-95%. The paint of the Comparative Example 2 was therefore also unacceptable for use in a solar thermal system.

TABLE 12
Results of comparative example 2 paint formulation.

| | | | Coating Absorptivity | |
|---|---|---|---|---|
| Tests | | | (% SCI) | |
| | | Neutral Salt Spray | After 2 hrs | After 100 hrs |
| Adhesion | Humidity | (8 hrs & 24 hrs) | @ 350° C. | @ 600° C. |
| Excellent | Failed | N/A | 96-96.5 | 93-95 |
| | after | | | |
| | 24 hours | | | |

Although the steps of a process for painting a surface have been described and illustrated together, it is of course contemplated that one or more steps can be performed separately or together, at the same time or at different times, at the same location or at different locations, and/or in the illustrated order or out of order. Additionally, it is contemplated that one or more steps can be optionally omitted. For example, as noted above, the formation of the passivation layer, the corrosion protection layer, and/or the anti-reflection coating may be omitted. In another example, a single layer of paint formulation may be applied to the metal article without any additional layers or treatments. In still another example, multiple layers of the paint formulation may be provided on top of each other.

In embodiments, an article of manufacture can include a heat transfer member having a receiving surface, which has an absorptivity of at least 80% with respect to the AM 1.5 spectrum and can be stable at temperatures greater than 750° C. for at least 1000 hours. The article can include a solar receiver and/or the heat transfer member can be part of a solar receiver. The heat transfer member can include a surface coating, e.g., a paint on the heat transfer member that defines properties of the receiving surface thereof.

Although particular formulations have been discussed herein, other formulations can also be employed. Furthermore, the foregoing descriptions apply, in some cases, to examples generated in a laboratory, but these examples can be extended to production techniques. For example, where quantities and techniques apply to the laboratory examples, they should not be understood as limiting. In addition, although certain materials, chemicals, or components have been described herein, other materials, chemicals (elemental or compositions), or components are also possible according to one or more contemplated embodiments.

Features of the disclosed embodiments may be combined, rearranged, omitted, etc., within the scope of the present disclosure to produce additional embodiments. Furthermore, certain features may sometimes be used to advantage without a corresponding use of other features.

It is, thus, apparent that there is provided, in accordance with the present disclosure, solar-radiation-absorbing formulations and related apparatus and methods. Many alternatives, modifications, and variations are enabled by the present disclosure. While specific embodiments have been shown and described in detail to illustrate the application of the principles of the invention, it will be understood that the invention may be embodied otherwise without departing from such principles. Accordingly, Applicants intend to embrace all such alternatives, modifications, equivalents, and variations that are within the spirit and scope of the present invention.

1. A paint formulation comprising:
an inorganic oxide-based pigment;
an organic binder;
at least one organic solvent; and
an inorganic filler;
wherein the organic binder is irreversibly converted to an inorganic binder upon curing of the paint formulation at a temperature greater than 200° C., and the oxide-based pigment and/or the paint formulation have an absorptivity of at least 80% with respect to the AM 1.5 spectrum.

2. A paint formulation comprising:
an inorganic oxide-based pigment;
an organic binder;
at least one organic solvent;
an inorganic filler; and
at least one additive;
wherein the organic binder is irreversibly converted to an inorganic binder upon curing of the paint formulation at a temperature greater than 200° C., and the oxide-based pigment and/or the paint formulation have an absorptivity of at least 80% with respect to the AM 1.5 spectrum.

3. The paint formulation of claim 1, wherein the paint formulation is stable at 750° C.

4. The paint formulation of claim 1, wherein the oxide-based pigment includes a spinel.

5. The paint formulation of claim 4, wherein the oxide-based pigment includes at least one selected from a manganese ferrite black spinel, a chromium cobalt iron black spinel, a copper chromite black spinel, and a nickel iron chromite black spinel.

6. The paint formulation of claim 4, wherein the oxide-based pigment includes a reaction product of high temperature calcination in which manganese (II) oxide, iron (II) oxide, manganese (III) oxide, and iron (III) oxide are homogenously and ionically interdiffused to form a crystalline matrix of spinel.

7. The paint formulation of claim 1, wherein the oxide-based pigment includes at least one selected from Cr203, CoO, CuO, Fe203, NiO, and Mn02.

8. The paint formulation of claim 1, wherein the organic binder includes at least one selected from a silicone resin, a silicone resin copolymer, a silicon-polyester resin, and a silicone-epoxy resin.

9. The paint formulation of claim 8, wherein the organic binder i includes at least one selected from a methyl polysiloxane, a phenyl polysiloxane, a medium-hard phenylmethyl silicone resin, a medium-hard high solid phenylmethyl silicone resin, a soft phenylmethyl silicone resin, a dimethyl polysiloxane, a phenyl-methyl polysiloxane, a propyl-phenyl polysiloxane silicone resin and a polydimethylsilazane.

10. The paint formulation of claim 1, wherein the pigment is at a concentration between 2% (wt/wt) and 40% (wt/wt).

11. The paint formulation of claim 1, wherein the organic binder is at a concentration between 10% (wt/wt) and 60% (wt/wt).

12. The paint formulation of claim 1, wherein the inorganic filler is a silicate-based material that forms layered inorganic microstructures in the paint formulation when applied to a substrate.

13. The paint formulation of claim 10, wherein the inorganic filler is one of mica, micaceous iron oxide, talc, or clay.

14. The paint formulation of claim 1, further comprising at least one selected from a wetting agent, a dispersing agent, a thickening agent, a de-foaming agent, an agent to improve electrostatic or other types of spraying, and an agent to prevent settling.

15. The paint formulation of claim 1, wherein said organic solvent includes at least one selected from 4-CBTF, a glycol ether, an aromatic naphtha solvent, butyl acetate, toluene, a member of the xylene family, dipropylene glycol mono methyl ether and dipropylene glycol methyl ether acetate.

16. The paint formulation of claim 15, wherein the solvent is at a concentration between 10% (wt/wt) and 60% (wt/wt).

17. An article of manufacture, comprising:
a heat transfer member having a receiving surface,
the receiving surface having an absorptivity of at least 80% with respect to with respect to the AM 1.5 spectrum, which is maintainable at temperatures of 750° C. for at least 1000 hours.

18. The article of claim 17, wherein the heat transfer member is a part of a solar receiver.

19. The article of claim 17, wherein the heat transfer member has a surface coating.

20. The article of claim 17, wherein the heat transfer member has a paint thereon defining properties of said receiving surface.

21. The article of claim 20, wherein the paint has the formulation of claim 1 or 2.

22. The article of claim 17, wherein the article includes a solar receiver.
